(19) United States
(12) Patent Application Publication
(10) Pub. No.: US 2021/0177552 A1
(43) Pub. Date: Jun. 17, 2021

(54) APPARATUS FOR ZYGOMATIC IMPLANTATION AND METHOD

(71) Applicant: NORIS MEDICAL LTD., Nesher (IL)

(72) Inventors: Aharon SIEV, Haifa (IL); Rami SIEV, Haifa (IL)

(73) Assignee: NORIS MEDICAL LTD., Nesher (IL)

(21) Appl. No.: 17/187,537

(22) Filed: Feb. 26, 2021

Related U.S. Application Data
(63) Continuation of application No. PCT/IL2019/050956, filed on Aug. 27, 2019.

(30) Foreign Application Priority Data
Aug. 30, 2018 (IL) 261494

(51) Int. Cl. A61C 8/00; A61C 1/08; B33Y 80/00

(52) U.S. Cl. CPC A61C 8/0034; B33Y 80/00; A61C 1/084

(57) ABSTRACT

An apparatus for implantation of a zygomatic implant in coincidence with an implantation vector includes a dedicated dental tool and a dental implantation guide including a guide shell configured to conform to and to be releasably affixed to a portion of a maxillary bone. The guide shell supports a plurality of guides including an anterior guide and a posterior guide which together form a pair of guides that are distanced apart relative to each other, are configured to be aligned with the implantation vector, and are configured as concave troughs for support of a cylindrical body, the cylindrical body being at least one of the zygomatic implant, the dedicated dental tool, an implantation drill, and a preliminary drill.

### CROSS-REFERENCE TO RELATED APPLICATIONS

The present application is a Continuation of International Patent Application No. PCT/IL2019/050956, filed Aug. 27, 2019, and claims the benefit of priority of Israeli Patent Application No. 261494, filed Aug. 30, 2018, the entire contents of both of which are incorporated herein by reference.

### TECHNICAL FIELD

The embodiments described hereinbelow relate to the field of implantation of dental implants, and in particular to apparatus and methods for guidance and implantation of extra maxillary and intra maxillary sinus zygomatic implants.

### DESCRIPTION OF RELATED ART

Zygomatic implants are well known for years as dental implants for the upper jaw, or maxilla.

One problem with prior art zygomatic implants is that a dentist must correctly guide and operate a free hand-held drill rotating osteomatic device, such as a drill rotated by a handpiece, to drill in a precise direction into a bone of the skull, which bone may be hidden from view, along a predetermined oriented direction. It has to be considered that straying from the desired predetermined oriented direction may damage organs hit by the drill. Such damage is sometimes irreparable. It would therefore be beneficial to provide a simple dental apparatus that will ensure stable guidance in well orientated direction along a preplanned selected vector of implantation.

### SUMMARY OF INVENTION

The embodiments disclosed herewith relate to an apparatus, methods and products for zygomatic implantations. Zygomatic implantations refer to dental implants which are implanted in the maxilla, i.e. the upper jaw. There is described an apparatus for implantation(s) of zygomatic implant(s) and for guiding preparations for implantation of implants. The implants are implanted in coincidence with a previously derived implantation vector. The apparatus includes a guide shell which is disposed on a portion of the maxilla and is configured to support guides. The guides include an anterior guide operative in association with a posterior guide, and the guides form a pair of guides. The pair of guides are distanced apart and are inverted relative to each other. Inverted means that when a guide such as an anterior guide is supported on a cylindrical body, then the posterior guide is disposed diametrically opposite thereto. A cylindrical body may be driven into the pair of guides and a moment of forces may be applied onto the cylindrical body. When a moment of forces is applied in a direction causing a resultant force of reaction from each guide GD, or the maximal force of reaction, then the cylindrical body CB is coaxially aligned with the vector V. The cylindrical body may be one or more of a zygomatic implant, an implantation drill, a preliminary drill, at least one-dedicated dental tool.

For one out of the pair of guides, inverted means that when a guide such as an anterior guide is supported on a cylindrical body, then the posterior guide is disposed diametrically opposite thereto.

The apparatus may further include a slit guide SLTGD to guide one or more dedicated dental tools DDNTL in alignment with the vector V. In addition, the apparatus may operate for an extra maxillary implantation(s) and for intra sinus implantation(s).

There is also provided a method for implementing an apparatus for preparing implantation and for safely implanting zygomatic implant(s) in coincidence with an a priori derived vector V of implantation. Safely means preventing physical damage to a patient such as for example hurting an eye.

Each guide may be configured as a trough guide. The guides are also configured to guide an implantation drill to drill a bore for implantation of the zygomatic implant in coincidence with the vector. The trough of the anterior guide is inverted relative to the trough of the posterior guide. The trough of the posterior guide has an anterior portion which protrudes out of and away from the surface of the guide shell GDS. Dental tools DNT are operated in association with the pair of guides GD.

There is provided an apparatus wherein a moment of forces applied on a portion of the implantation drill IMDRL which is seated between the pair of guides PRGD urges the implantation drill IMDRL in alignment with the vector V.

There is further provided an apparatus wherein each one out of the anterior guide AGD and the posterior guide PGD is configured to receive a portion of a cylindrical body CB having a guide-matching exterior diameter D in firm seated support therein in alignment with the implantation vector V, and each one out of the zygomatic implant ZI and of the at least one dental tool DNT having a portion of a guide-matching exterior diameter D is firmly seated in the pair of guides PRGD.

There is also provided an apparatus wherein each one out of the anterior guide AGD and the posterior guide PGD is configured to receive a portion of a cylindrical body CB of matching exterior diameter D in firm seated support therein on at least two points of contact CP, wherein relative to portions of the matching cylindrical body CB, the at least two points of contact CP disposed on the anterior guide AGD are closer to the maxilla MAX than the at least two points of contact CP disposed on the posterior guide PGD, and portion(s) of a matching cylindrical body CB of a zygomatic implant ZI and of at least one out of the dental tools DNT are configured to be firmly seated in the pair of guides PRGD.

Thus, an apparatus including dental tools and dental implantation guides can be provided for releasable affixation to the maxillary bone, to guide preparations of implantation, the drilling of the implantation bore, and the anchoring of the zygomatic implant without deviation from the implantation vector selected by a dentist.

In the description, a drill is defined as a dental bore-cutting tool, such as for drilling into a bone or a tooth, and the machine rotating the drill is defined as a handpiece, which is not shown in the drawings.

A vector, or implantation vector, is defined as an entity having a point of origin, an end point, a length, and a direction of orientation in space.

An implanted zygomatic implant is considered to coincide with the vector, or vector of implantation. Tools for use with the dental implantation guide may be aligned, which means coaxially aligned with the vector, thus coaxially aligned with the axis of symmetry of a zygomatic implant.

One advantageous effect of the invention is that the dental implantation guide ensures that the implant will be inserted in coincidence with the selected implantation vector, without straying away therefrom, and will therefore be safe and void of medical complications caused to by the implantation to other organs in the skull.

Another advantage is the ease and simplicity of the dental procedure. Still another advantage is the brevity of the dental intervention.

The apparatus for zygomatic implantation including the guide shell and the dedicated tools may be produced by manufacturers and by laboratories supplying dental equipment.

### BRIEF DESCRIPTION OF DRAWINGS

Non-limiting embodiments of the invention will be described with reference to the following description of exemplary embodiments, in conjunction with the figures. The figures are generally not shown to scale and any measurements are only meant to be exemplary and not necessarily limiting. In the figures, identical structures, elements, or parts that appear in more than one figure are preferably labeled with a same or similar number in all the figures in which they appear, in which:

FIG. 1 shows a profile line of a cross-section of the maxilla,

FIG. 2 depicts a cross-section of an embodiment,

FIG. 3 isometrically illustrates an exemplary guide shell,

FIGS. 4 to 6 depict embodiments of guides,

FIG. 7 illustrates inverted guides supporting a cylindrical body,

FIGS. 8 to 11 show more embodiments of guides,

FIGS. 12 to 20 refer to the use of an embodiment,

FIG. 21 isometrically illustrates a guide shell for two implantations,

FIG. 22 illustrates the support of a cylindrical body,

FIG. 23 isometrically illustrates another exemplary guide shell

FIG. 24 is a cross-section of an embodiment,

FIGS. 25 to 28 depict further embodiments of guides,

FIGS. 29 to 38 illustrate the use of an embodiment,

FIG. 39 isometrically illustrates another guide shell for two implantations,

FIGS. 40 to 45 refer to intra sinus implantation,

FIG. 46 illustrates two stages of implantation, and

FIG. 47 isometrically illustrates a guide shell for two intra sinus implantations.

### DESCRIPTION OF EMBODIMENTS

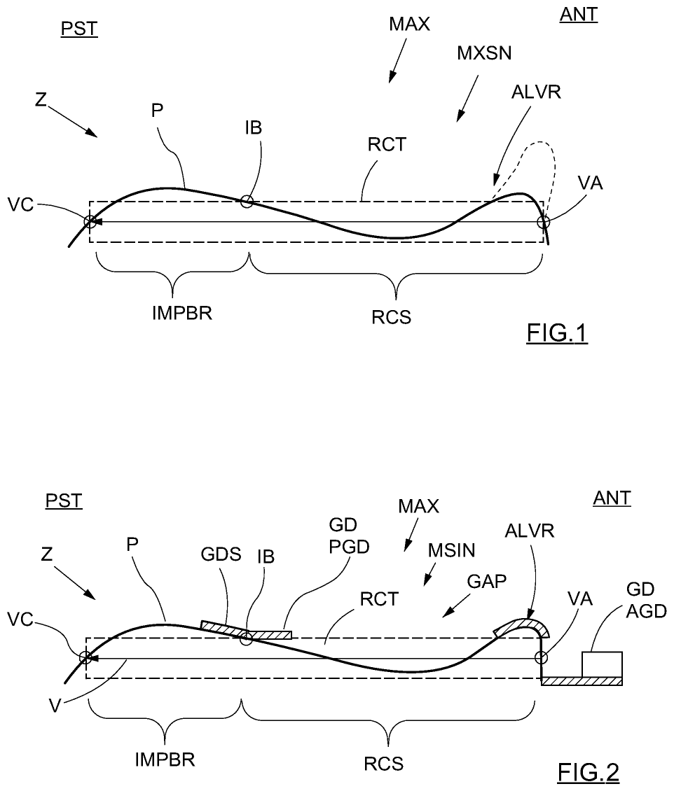

FIG. 1 is an illustration used for the sake of orientation and ease of description.

FIG. 1 schematically depicts the shape of a profile line P of a cross-section taken through the naked maxilla bone MAX, thus from which tissue has been folded-over or removed. The profile line P is disposed in a plane cut through the axis of an implantation bore IMPBR opened for implanting therein of an extra maxillary zygomatic implant ZI coinciding with a planned implantation vector V selected by a dentist. The implantation vector V, or vector V of implantation, may pass from the anterior ANT alveolar ridge ALVR, via the maxillary sinus MXSN to the posterior PST zygomatic bone Z. Such a profile line P for a particular person may be obtained by use of CAD/CAM computer programs operated on images derived by three-dimensional imaging facilities. The dashed-line rectangle RCT superimposed on the profile line P represents a cross-section cut in the plane of the profile P, of a cylinder enveloping a rather cylindrical zygomatic implant ZI. Actually, the anchoring portion of a zygomatic implant ZI may be conic, thus not perfectly cylindrical, therefore, the rectangle RCT is an approximation.

The rectangle RCT is a cross-section of a general cylindrical body CB having an exterior diameter D, possibly like that of the cylindrical portion of a zygomatic implant ZI or of a dental tool. For a generally cylindrical body CB having more than one cylindrical portion, the same denomination D for the exterior diameter refers to the exterior diameter of each one out of the specific cylindrical portions, as shown in FIG. 22. For example, with a zygomatic implant ZI having two cylindrical portions, even though each one portion may have a different exterior diameter, each portion may still be referred to as having an exterior diameter D. ‘A portion of a cylindrical body of diameter D supported by a matching guide GD’ means that the guide GD matches the diameter D of that specific portion of the cylindrical body, as shown in FIG. 22.

On the profile line P, the point VA indicates the anterior point of the implantation vector V, and the point VC marks the point of the posterior anchoring end of the vector V, which point VC is the limit that the posterior end of the zygomatic implant ZI may not trespass. The point VC may be disposed just posterior out of the zygoma bone Z but may not penetrate tissue and skin on the zygoma bone Z. With an extra maxillary zygomatic implantation, the point IB is the most posterior point of intersection of the rectangle RCT with the zygomatic bone Z. In general terms, an anterior portion of the rectangle RCT, from point VA to point IB, may mark the portion of the maxilla MAX along which a recess RCS will be prepared for the zygomatic implant ZI. The portion of the rectangle RCT from point IB to point VC includes the implantation bore IMPBR. The implantation vector V thus extends from point VA to point VC, and the zygomatic implant ZI has to coincide with the implantation vector V.

In the description, an implanted zygomatic implant ZI is considered to coincide with the vector V, or vector of implantation. Zygomatic implants ZI and tools for use with the dental implantation guide(s) may be aligned with the vector V, which means coaxially aligned with the vector V, thus also coaxially aligned with the axis of symmetry of a zygomatic implant ZI. Parallel to the vector V is thus different from alignment with the vector V, which alignment means coaxial alignment with the vector V.

FIG. 2 depicts a cross-section of a portion of a guide shell GDS pertaining to the apparatus, which guide shell GDS covers a portion of the profile line P, thus covers a portion of the maxilla MAX. The guide shell GDS extends to the anterior of the alveolar ridge ALVR, thus anterior to the point VA, and ends posterior to the point IB, which point IB indicates the posterior intersection point of the rectangle RCT with the zygomatic bone Z. A gap GAP may extend from a point somewhat anterior to the point VA up to a point somewhat posterior to the point IB. More gaps GAP may be opened in the guide shell GDS.

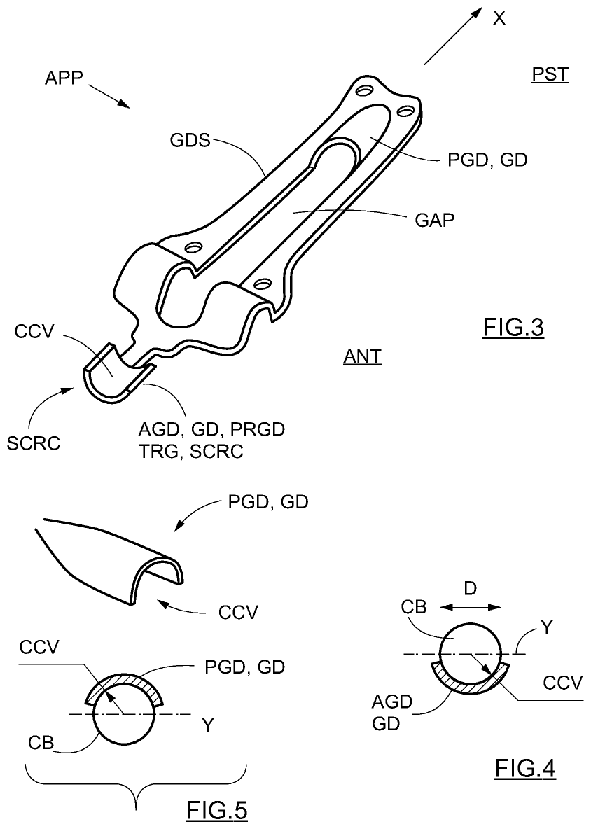

FIG. 3 illustrates an exemplary embodiment of a guide shell GDS, configured for one implantation, to support one pair of guides PRGD, which means two guides GD, namely an anterior guide AGD and a posterior guide PGD. The guide shell GDS may be configured to support more than one pair of guides PRGD, for each one pair of guides PRGD to be used for a different implantation. The guides GD may be shaped as a portion of a concave trough TRG, say having a semi-circular shape SCRC, or a concave V-channel VCH, or having another desired shape. FIG. 2 shows a concave posterior guide PGD, such as a trough TRG, which extends anteriorly away from the intersection point IB and gradually away from the guide shell GDS for passage therethrough. As better seen in FIGS. 3, the concave portion of the posterior guide PGD is inverted relative to the concave portion of the anterior guide AGD.

FIG. 3 shows an exemplary embodiment of the anterior guide AGD which may be shaped as a portion of a concave CCV trough TRG having for example a somewhat semi-circular shape SCRC which is supported anterior to the point VA shown in FIG. 1. FIG. 4 shows a cross-section of a cylindrical body CB having an exterior diameter D which is received in matching disposition and is firmly rested in the concave portion CCV of the anterior guide AGD. FIG. 5 is a detail of an exemplary embodiment of the posterior guide PGD, and a cross-section of a cylindrical body CB having an exterior diameter D which is received in matching disposition and is firmly rested in the concave portion CCV of the posterior guide PGD. It is noted that the anterior guide AGD as well as the posterior guide PGD cover at most, but preferably less than, half of the periphery of the cylindrical body CB, which is advantageous for release of the guide shell GDS from the maxilla MAX when there is provided an appropriate gap GAP, as shown in FIG. 3.

The guide shell GDS is preferably configured to conform with and for releasable affixation to the maxilla MAX. A zygomatic implant ZI which is firmly inserted into and supported by the pair of guides PRGD will thus be aligned with the vector V. Release of the guide shell GDS from the maxilla MAX is possible when desired, and also either after drilling the implantation bore(s) IMPBR, or after completion of the implantation(s).

Furthermore, the concave portion CCV of the anterior guide AGD which faces away from the maxilla MAX is inverted relative to the concave portion CCV of the posterior guide PGD which faces towards the maxilla MAX. The face of the concave portion CCV of a guide GD is accepted as being that opening of the guide via which the cylindrical body CB is introduced to become firmly seated in a guide GD out of the pair of guides PRGD.

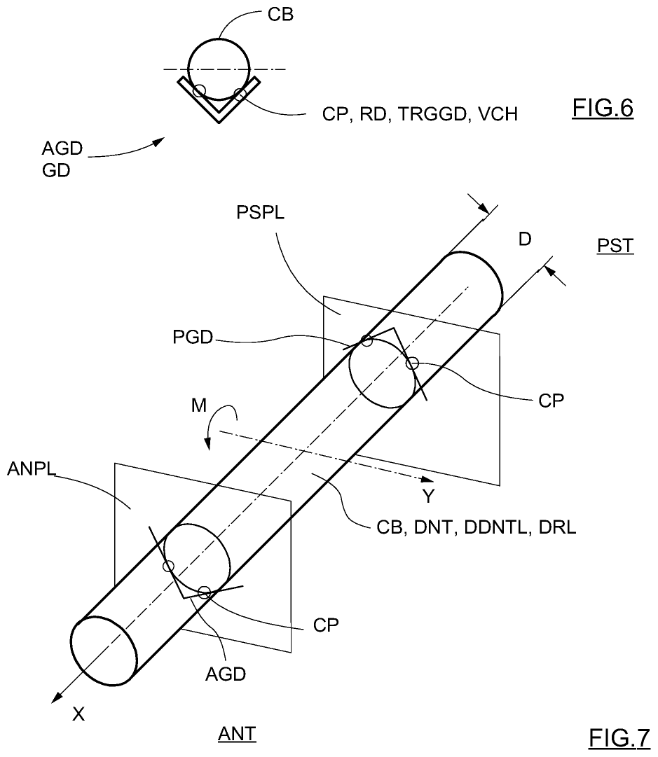

FIG. 6 illustrates a cross-section of an exemplary anterior trough-shaped guide AGD formed as a V-block, also practical as a posterior guide PRG when inverted relative to the anterior guide AGD shown in FIG. 6. Like other guides GD practical for pairs of guides PRGD, the V-block guide GD may support a cylindrical body CB on two points of contact CP, or along two parallel segments of a line parallel to the vector V, or on two surfaces of the guide GD. In FIG. 6, the cylindrical body CB is shown to be supported by an anterior guide AGD shaped as a V-block which is limited to cover at most, but preferably less than, half of the periphery of the cross-section of the cylindrical body CB. A guide GD out of the pair of guides PRGD and out of the various shapes and bodies practical to operate as a guide GD, may be referred to hereinbelow as an anterior guide AGD, a posterior guide PGD, and as a trough guide TRGGD.

### Guide Shell

The guide shell GDS for a zygomatic implantation is a structure which supports at least one pair of guides PRGD. The guide shell GDS is the interface which couples the pair(s) of guides PRGD to the bones of the skull of an individual person. Therefore, the guide shell GDS has to be custom made to the shape of at least a portion of the uncovered and naked portion of the maxilla MAX of the treated individual. Commonly available three dimensional, or 3D, imaging facilities allow to retrieve detailed data regarding the structure of the skull bones, which data may be used by CAD/CAM computer programs to allow a dentist to plan the implantation procedure and to allow a designer to design and produce a tailor-made guide shell GDS. It is by help of the 3D imaging facilities and of CAD/CAM computer programs that a dentist may select the vector V of implantation of one or more zygomatic implants ZI.

A vector V of implantation defines a direction of orientation in the 3D volume of the skull, an anterior point of origin VA, and a posterior end point VC, thus also a length. Additional retrieved data may be accompanied with geometrical spatial relationships between the bones of the skull and the zygomatic implant ZI. A different vector V has to be selected for each implant.

A guide shell GDS may be made out of at least one rigid material, has to support at least one pair of guides PRGD, and has to conform to a portion of the surface of the uncovered maxillary bone MAX. Furthermore, means for releasable affixation of the guide shell DGS to the maxilla MAX may include screws, and/or pins, and/or adhesives.

In the description hereinbelow, a cylindrical body CB of diameter D is used to represent at least a portion of a zygomatic implant ZI, or of a common tool DNT used for implantation having the same diameter D, or of a dedicated dental tool DDNTL specific for assistance with an implantation procedure by use with the apparatus APP. For example, tools may include drills, burrs, and guides. Hence, a guide GD configured to receive a cylindrical body CB of diameter D therein is considered a being configured to receive a zygomatic implant ZI or a dental tool in matching support therein.

A dedicated dental tool DDNTL is a dental tool DNT which is dedicated for use with the apparatus APP described herewith. Dedicated dental tools DDNTL are included in and pertain to the apparatus APP, contrary to commonly available dental tools DNT.

FIG. 7 schematically illustrates a cylindrical body CB of diameter D cut by an anterior plane ANPL and by a posterior plane PSPL which are distanced apart from each other. Each one of the anterior plane ANPL and the posterior plane PSPL shows respectively, two points of contact CP on an anterior guide AGD and on a posterior guide PGD, as a support for the cylindrical body CB. The anterior guide AGD and the posterior guide PGD are shown to be inverted relatively to each other. Irrelevantly of the shape of the pair of guides PRGD, two points of contact CP appropriately disposed diametrically opposite to each other on the periphery of a cross-section of the cylindrical body CB on the anterior plane ANPL and on the posterior plane PSPL, are sufficient to stably support the cylindrical body CB on the guides GD. This means that a moment of forces M applied about an axis Y perpendicular to the longitudinal axis X of the cylindrical body CB, say for that body CB to be urged into the anterior guide AGD, that cylindrical body CB will be urged into stable and firm support by the pair of guides PRGD. Thereby, the cylindrical body CB is correctly aligned with the vector V and is limited to freedom of motion in rotation and in translation.

For example, a handpiece, not shown, may be used to introduce an implantation drill IMDRL in seated support on the pair of guides PRGD, and to apply a moment of forces M on that drill to be firmly urged into the anterior guide AGD. Thereby, the implantation drill IMDRL will be forced into the posterior guide PGD. Even when the posterior guide PGD is hidden from of view, the resultant moment M of forces from the pair of guides PRGD will indicate that the implantation drill IMDRL is coaxially aligned with the vector V. Hence, the apparatus APP may be used even when the posterior guide PGD is hidden from view, such as may occur for example with intra sinus implantations.

The benefits resulting from the application of a moment of forces M is a basic feature which is valid for the various exemplary embodiments described herewith.

FIG. 3 illustrates that a guide shell GDS may be made as one piece of one type of rigid material, such as metal, which may be selected as Titanium for example, and may be produced say by a three-dimensional lithographic printing machine. To save on costs, a rigid guide shell GDS may be produced out of material which is less expensive and is advantageous for 3D lithography printing. Plastic material may also be considered. It is possible to regard each contact point marked CP in FIG. 6 as showing a cross-section of a wire RD or of a rod RD harder than or less erodible than plastic. Such a rod RD may be supported by a guide GD and be oriented along a longitudinal line segment parallel to the vector V. The interface between a rotating cylindrical body CB such as a drill DRL and a guide GD, may be selected for example, as at least two separated apart parallel rods RD of material less erodible than plastic, which may be embedded in or retained by plastic material or other material(s), and may become a guide GD. FIG. 6 may thus be considered to represent a cross-section of such a guide GD where the cylindrical body CB is supported on metal, here the rods RD, so as not to abrade the plastic material out of which the guide GD or the shell GDS may be made, and maintain precise orientation in alignment with the vector V.

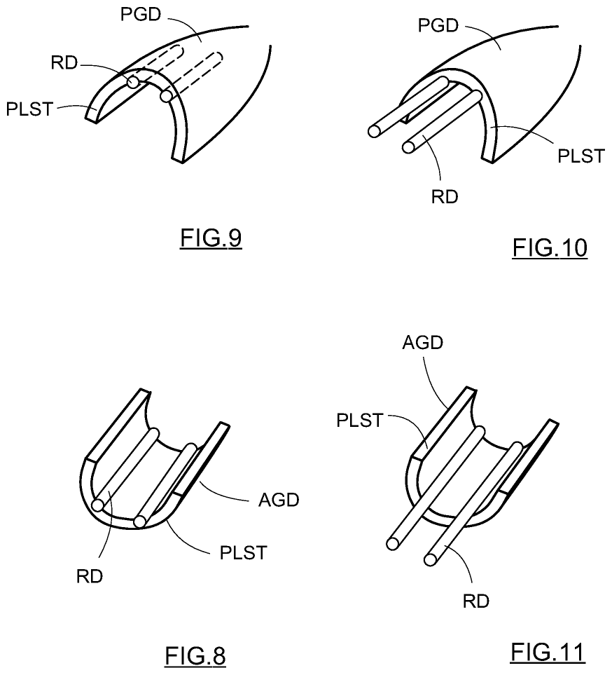

FIGS. 8 and 9 depict exemplary embodiments of, respectively, an anterior guide AGD and of a posterior guide PGD pertaining to a guide shell GDS made of plastic material PLST, wherein two parallel rods RD have been embedded parallel to the vector V. Hence, a guide shell GDS may be made out of one or more materials, of the same type of material or not, and be reinforced by the same or with other types of material. FIGS. 10 and 11 show an exemplary embodiment of, respectively, a posterior guide PGD and an anterior guide AGD, each one supporting two parallel cantilevered rods RD which extend anteriorly away from those guides GD, and may be embedded in plastic material PLST for example.

It is noted that such rods RD are applicable to various guides GD of different shape, as inserts or as guides GD that may or not extend anteriorly away from the guide GD to which they are coupled. For example, the contact points CP shown in FIG. 6 may be implemented as rods RD which may or not extend thereout.

The exemplary embodiments described hereinbelow are used for zygomatic implantation(s) ZI in the zygoma bone Z. As described by Wikipedia on the Internet at “Zygoma Implant”, zygoma implants ZI are used for dental rehabilitation when there is insufficient bone in the maxilla, or upper jaw.

The preparations for the implantation of a zygomatic implant ZI requires osteotomy of the bones of the skull to be performed. Osteotomy is defined as the treatment or processing of bones, including cutting, drilling, burring, and the like, and is performed by use of osteotomic tools. Osteotomy is thus accepted as referring to the removal of a portion of a bone, which may proceed through a series of successive steps. It is noted that with the exemplary embodiments described hereinbelow, the osteotomic steps are guided by and in association with the various guides GD, including the guides supported by the guide shell GDS, the guides provided as dedicated dental tools DDNTL, and possibly further guides. With a step of operation requiring alignment with the vector V, the use of one guide GD from the beginning to the end of that step is not considered to be sufficient to ensure correct alignment. Dedicated dental tools DDNTL are tools which pertain to and are included in the apparatus APP, and are operative therewith together with the guide shell GDS.

### Planning, Preparations, and Implantation

Planning prior to implantation requires selecting and defining the vector of implantation V, whereafter the guide shell GDS may be designed and fabricated. By help of the three-dimensional imaging facilities and of computer processing facilities running computer programs, such as CAD/CAM computer programs for example, a dentist may derive data to select and define a vector V of implantation of one or more zygomatic implants ZI. In turn, based on the derived data, a technician may design and produce an individual tailor-made guide shell GDS in conformance with the topography of the maxilla MAX of a patient by use of a three-dimensional lithographic additive printer for example. Evidently, the topography of the maxilla MAX which is different for each individual, has to be retrieved a priori.

Preparations prior to use assume that a vector V has been defined and that tissue covering the maxillary bone MAX has been folded-over, or removed, to expose a naked bone portion of the maxilla MAX.

Use, in broad terms, may include the following steps as applied to the use of the exemplary embodiments of the apparatus APP.

As a first step, use of the apparatus APP requires that the guide shell GDS be properly disposed and releasably affixed to and in conformance with the topography of the maxilla MAX, such that the pair of guides PRGD are correctly oriented relative to the vector V. In FIG. 2, the implantation vector V is represented by the segment of line stretching from the points VA to VC, and the pair of guides PRGD is oriented accordingly.

The steps necessary for use with an exemplary embodiment of the apparatus APP are describe hereinbelow. An embodiment may include a guide shell GDS, common dental tools, as well as dedicated dental tools DDNTL specifically designed for operation with a selected embodiment of the apparatus APP. For the sake of ease of illustration, the pair of guides PRGD may be selected to have many possible configurations, and are depicted and referred to as semicircular troughs TRG. A pair of guides PRG may include guides of different configuration, such as depicted in FIGS. 4 to 6, and 8 to 11, and others. For example, a pair of guides PRG may include a semicircular trough TRG disposed inverted to a V-block shape.

In a first osteotomy step, a first volume of bone is removed from the maxilla MAX, to provide an initial first cavity FRTCV from which the next osteotomy steps will proceed.

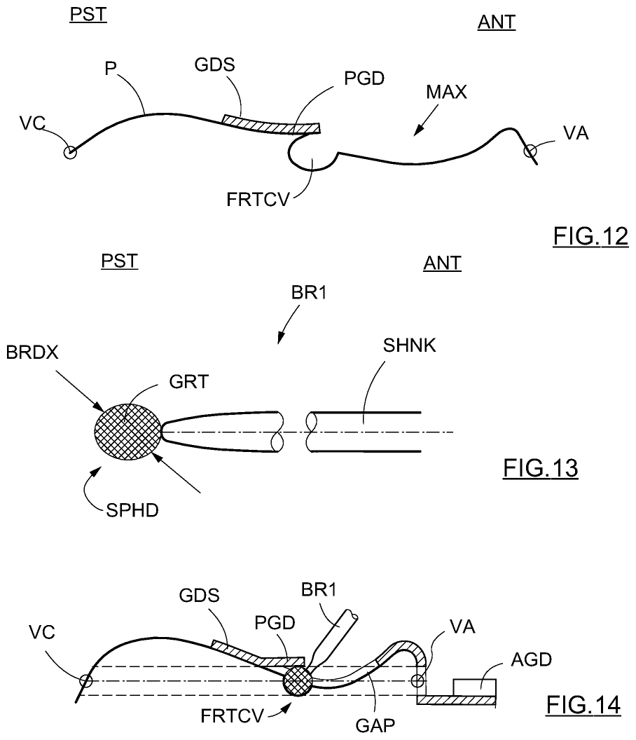

FIG. 12 illustrates the result of the first osteotomy step performed to create the first cavity FRTCV under guidance of the posterior guide PGD, by use of a first tool having a spherical headed burr BR1 shown in FIG. 13. The anterior guide AGD is not shown in FIG. 12.

In FIG. 13, the osteotomic burr BR1, is shown to have an abrasive spherical head SPHD which is coupled to a cylindrical shank SHNK that terminates the burr tool BR1. The spherical abrasive head SPHD may have an appropriately selected exterior diameter BRXD, such as the exterior diameter D of the zygomatic implant ZI which may be equal to 4.2 mm.

FIG. 14 depicts the use of the first burr BR1 to form the first cavity FRTCV. The shank SHNK may be engaged slant relative to the posterior guide PGD. To open the first cavity FRTCV shown in FIG. 12, the burr BR1 is rotated, say by a handpiece, not shown, and is introduced into the posterior guide PGD to cut into the bone of the maxilla MAX. The dental burr tool BR1 may be handled and pivoted to obtain a desired first cavity FRTCV.

It is noted that to avoid abrasion of the posterior guide PGD, a portion of the spherical head SPHD adjacent the shank SHNK, may be kept smooth while the remaining portion of the head SPHD may be covered for example with abrasive diamond, tungsten carbide, or titanium grit GRT, as shown in FIG. 13. Once the burr BR1 has opened the first cavity FRTCV to the depth of the diameter BRXD of the spherical head SPHD, that cavity is completed, and the first burr BR1 may be retrieved anteriorly out of the posterior guide PGD, and out of the first cavity FRTCV.

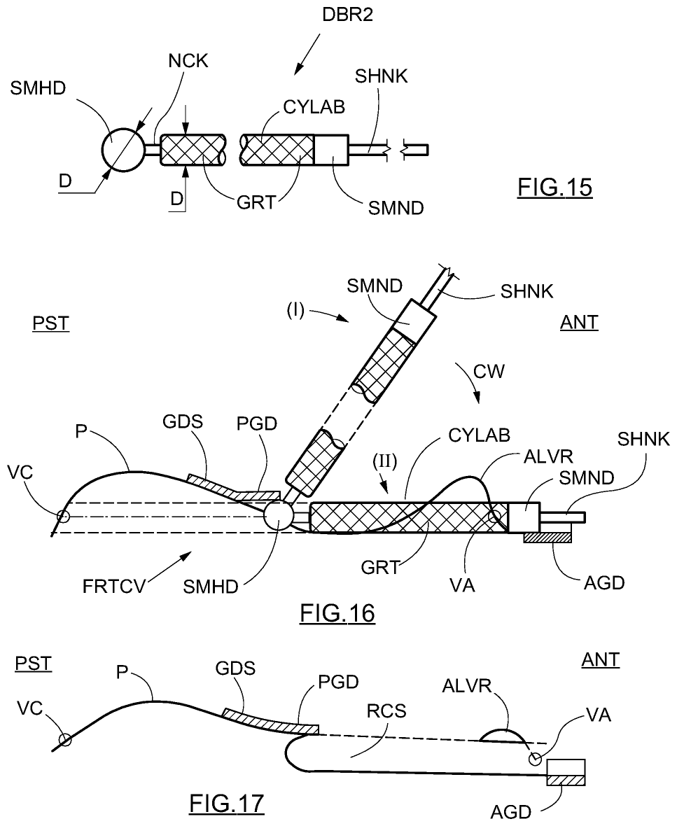

The second osteotomic step may take advantage of the first cavity FRTCV created by the first osteotomic step to open an anterior recess RCS extending from the first cavity FRTCV up to the point VA, i.e. the alveolar ridge ALVR. A second dedicated dental tool DDNTL, here a dedicated burr tool DBR2 having a smooth spherical head SMHD supported by a generally cylindrical abrasive body CYLAB, and a shank SHNK, as shown in FIG. 15, may be used to open the recess RCS.

FIG. 15 shows the dedicated dental burr tool DBR2, having a spherical smooth head SMHD coupled via a neck NCK to a cylindrical abrasive body CYLAB of diameter D of 4.2 mm for example. The abrasive body CYLAB may be covered for example with abrasive diamond, or tungsten carbide, or titanium grit GRT, or be implemented as a rotary chipping tool made from steel. A shank SHNK terminates the dedicated burr DBR2. With the spherical smooth head SMHSD seated as a fulcrum in the first cavity FRTCV, the abrasive body CYLAB is allowed pivotal motion in the plane defined by the posterior guide PGD and the anterior guide AGD.

FIG. 16 illustrates the use of the cylindrical abrasive body portion CYLAB of the dedicated burr DBR2 for opening a recess RCS which extends from the first cavity FRTCV to the point VA. The dedicated burr DBR2 is shown in two dispositions in FIG. 16, i.e. a first slant initial disposition (I), and after pivoting, a second end disposition (II) when seated in the anterior guide AGD. For the initial disposition (I), the dedicated burr DBR2 is inserted into the first cavity FRTCV with the smooth spherical head SMHD as a fulcrum, and is coupled to and operated into rotation by a hand piece, which is not shown. The dedicated burr DBR2 is then pivoted in the clockwise direction CW, shown in FIG. 16 by the arrow marked CW, towards the second disposition (II), until the cylindrical abrasive portion CYLAB is seated in the anterior guide AGD, whereby the osteotomy of the recess RCS opening procedure is ended. If desired, the dedicated burr DBR2 may have a cylindrical smooth end portion SMND to prevent abrasion of the anterior guide AGD when seated therein. The dedicated burr DBR2 may be retrieved out of the recess RCS which is exposed, as schematically shown in FIG. 17. The second step of osteotomy has thus been started under the guidance of the posterior guide PGD for making a first cavity FRTCV and is ended when the dedicated burr DBR2 is firmly seated in the anterior guide AGD.

To terminate the osteotomy of the implantation procedure, a third osteotomy step, namely the drilling of the implantation bore IMPBR in the zygomatic bone ZI has to be performed. Preferably prior thereto, another common dental tool DNT, namely a drill guide DRLGD is used. The drill guide DRLGD ensures stable axially centered support and coaxial alignment of a preliminary drill PRDRL with the implantation vector V, for example prior to use of the implantation drill IMDRL. A preliminary drill PRDRL is used to drill an orientation bore of lesser diameter than a next bore, i.e. such as an implantation bore IMPBR, to be drilled in the preliminary bore PRLBR. Thus, to ensure perfect alignment of the implantation bore IMPBR, a drill guide DRLGD is provided.

FIG. 18 illustrates the drill guide DRLGD as a bushing BSH of exterior diameter BSHOD of 4.2 mm for example, and having an interior diameter BSHid of 3.5 mm for example, adapted to be used with a preliminary drill PRDRL. A handle HDL may be coupled to the bushing BSH, perpendicular to the axis X thereof. The handle HDL allows a user to insert and hold the bushing BSH in the first cavity FRTCV in the posterior guide PGD in alignment with the vector V.

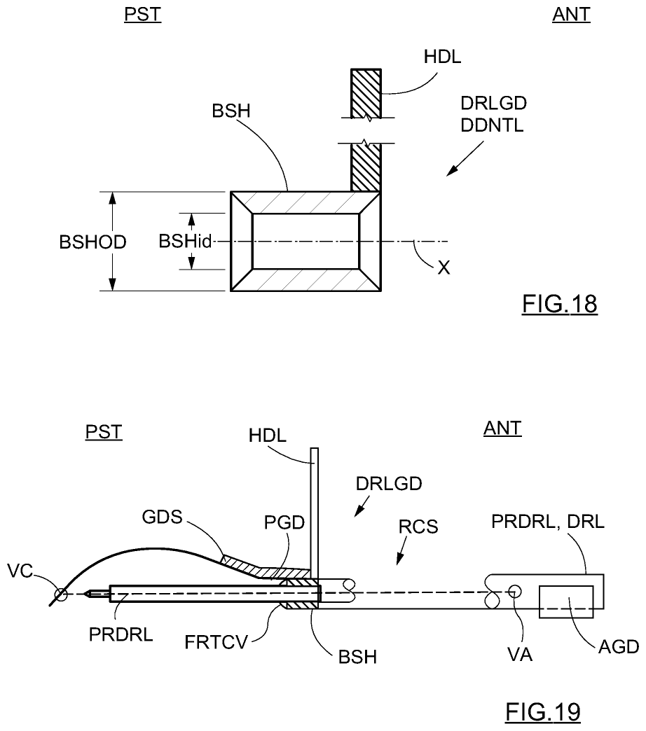

FIG. 19 depicts a drill guide DRLGD for support and orientation of a preliminary drill PRDRL. The preliminary drill PRDRL is axially centered in and by the interior diameter BSHid of the drill guide DRLGD which is axially oriented by the posterior guide PGD, and is firmly inserted in the anterior guide AGD. This means that the drill guide DRLGD is oriented in alignment with the vector V. The preliminary drill PRDRL is now mounted for rotation in a handpiece, which is not shown, and is then rotated. A preliminary bore PRLBR is drilled starting from the first cavity FRTCV until the preliminary drill PRDRL is arrested by the bushing BSH, as shown in FIG. 19. Thereafter, the preliminary drill PRDRL is retrieved, as well as the drill guide DRLGD.

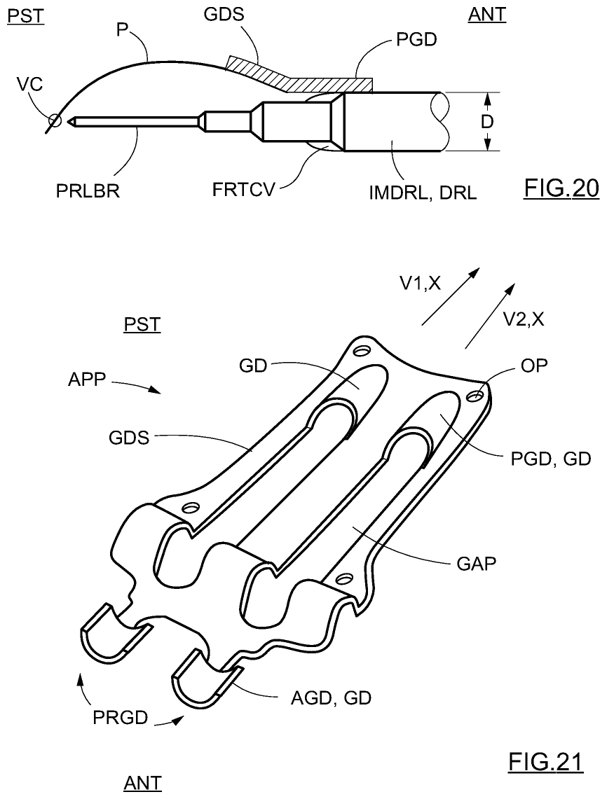

In a further step, the implantation drill IMDRL is mounted for rotation in a handpiece, which is not shown. In turn, the implantation drill IMDRL is disposed in support in the pair of guides PRGD, and the forces of a moment M are applied on the mutually inverted anterior guide AGD and posterior guide PGD, whereby the drill will be coaxially aligned with the vector V. A detail illustrated in FIG. 20 shows the diameter D, of say 4.2 mm for example, being urged into the posterior guide PGD. The implantation bore IMPBR is introduced in the preliminary bore PRLBR and is then rotated to drill to the desired depth, possibly by help of depth marks stamped on the shank of the implantation drill IMDRL. Finally, the implantation drill IMDRL is retrieved out of the guide shell GDS, whereafter the zygomatic implant ZI may be inserted in guidance by the pair of guides PRGD for coincidence with the vector V, and anchored.

After implantation, the gap(s) GAP opened in the guide shell GDS permit release thereof from the maxilla MAX.

FIG. 21 is a schematic illustration of a guide shell GDS supporting two pairs of guides PRGD which are not parallel to each other but could be disposed in parallel. One pair of guides PRGD is aligned along the vector V1 and the other pair of guides is aligned along the vector V2. A guide shell GDS may thus support more than one pair of guides PRGD.

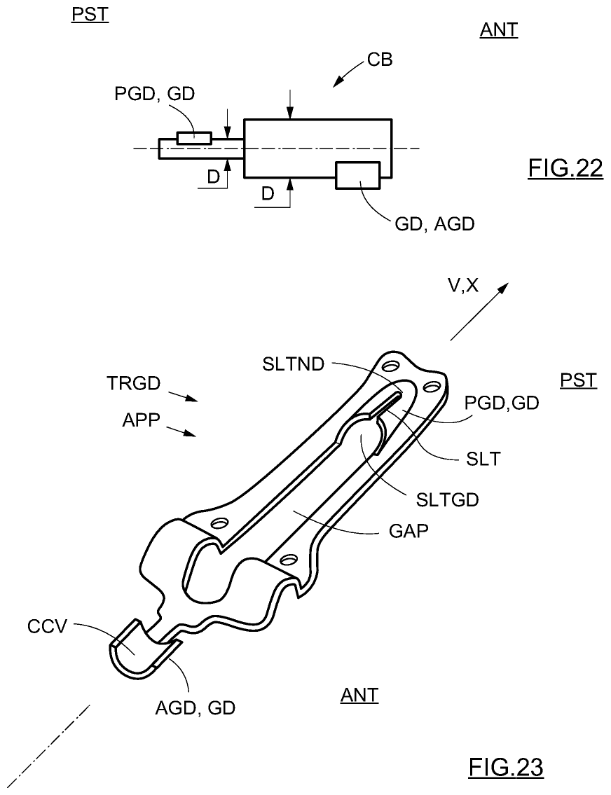

FIG. 23 illustrates another exemplary embodiment of the apparatus APP, this time with a guide shell GDS which supports three guides TRGD for guiding one implantation. The three guides TRGD include both the anterior guide AGD and the posterior guide PGD described hereinabove, with the addition of a third guide as a slit-guide SLTGD. The slit guide SLTGD is supported on the posterior guide PGD in which is formed a slit SLT opened parallel to the axis of a cylindrical body CB firmly inserted in the pair of guides PRGD, thus to be disposed parallel to the vector V, as shown in FIG. 23.

The description related hereinabove to the apparatus APP with reference to the FIGS. 1 to 11 is still valid for the guide shell GDS which supports three guides TRGD, but for the slit guide SLTGD and the use of the apparatus APP as related thereto, and is therefore not repeated.

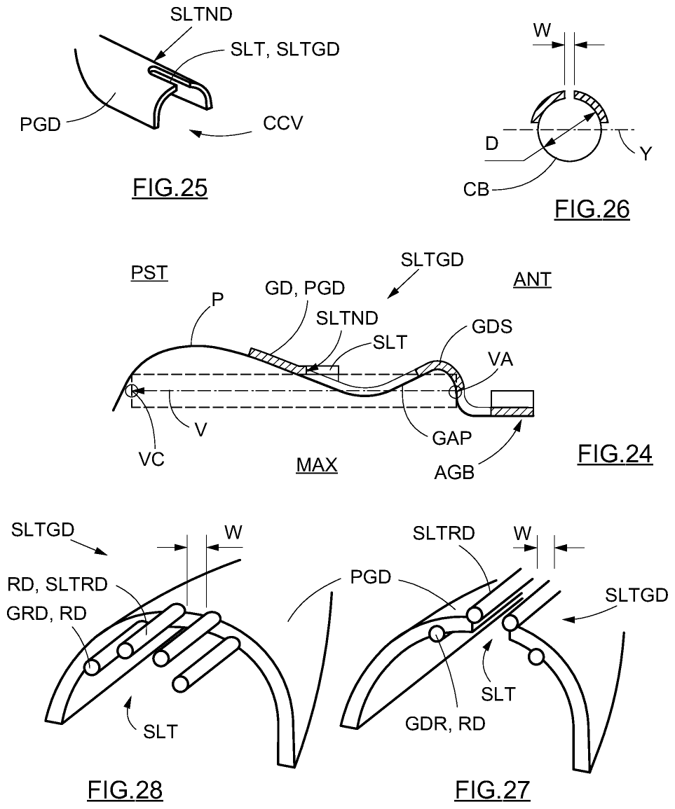

FIG. 24 is a cross-section of the guide shell GDS showing the pair of guides PRGD, i.e. the anterior guide AGD and the posterior guide PGD, as well as the slit guide SLTGD, the slit SLT, and the slit end SLTND.

FIGS. 23 and 24 depict a guide shell GDS operable for one implantation, but which is configured to support a plurality of three guides TRGD. A guide shell GDS may support a plurality of sets of three guides TRGD, for each set of three guides TRGD to be used for a different implantation. For the sake of ease of illustration, the anterior guide AGD and the posterior guide PGD pertaining to the pair of guides PRGD are referred to as concave troughs TRG, but other configurations of the pair of guides PRGD may be selected.

FIG. 25 is an isometric representation of a posterior guide PGD showing the slit guide SLTGD, the slit SLT, and the slit end SLTND. FIG. 26 is a cross-section perpendicular through a cylindrical body CB which is inserted in the posterior guide PGD. The cylindrical body CB has an exterior diameter D which is received in matching disposition and is firmly rested in the concave portion CCV of the posterior guide PGD. As described hereinabove with reference to FIGS. 4 and 5, the pair of guides PRGD may cover at most, and preferably less than, half of the periphery of the cylindrical body CB. Covering less than half of the periphery is advantageous for release of the guide shell GDS from the maxilla MAX when an appropriately configured gap GAP is provided. For operation, the guide shell is affixed to the maxilla MAX, but is later removed therefrom. Release of the guide shell GDS from the maxilla MAX is possible when desired, and also either after drilling the implantation bore(s) IMPBR, or after completion of the implantation(s).

In addition to the various configuration of the pair of guides PRGD as trough guides TRGGD depicted in FIGS. 3 to 6, and 9-11, additional configurations may be considered with a guide shell GDS having a posterior guide PGD which supports a guide slit GDSLT, as shown in FIGS. 27 and 28. FIGS. 27 and 28 illustrate a posterior guide PGD having a slit SLT which is implemented as two parallel slit rods SLTRD separated apart by a width W which is the width W of the slit SLT.

In FIG. 27 the posterior guide PGD has two embedded slit rods SLTRD which form the slit SLT, and a slit SLT which is implemented as two parallel slit rods SLTRD separated apart by a width W which forms the slit SLT and two more parallel guide rods GRD to support a cylindrical body CB. The rods RD may be made embedded and may be made of the same or out a different material than the guide shell GDS.

FIG. 28 depicts four parallel rods RD including two parallel guide rods GRD and two parallel slit rods SLTRD forming the slit guide SLTGD. Each one of the rods RD pertaining to the guide rods GRD and to slit rods SLTRD may protrude anteriorly out and away from the posterior guide PRG. The various configuration of the slit guides SLTGD shown in FIGS. 27 and 28, as well as other configurations clear to those skilled in the art, are included in a collection of guide configurations which may be named as trough guides TRGGD.

The slit guide SLTGD, the posterior guide PRG and the guide shell GDS may be implemented out of a same or out of different materials.

Planning, Preparations, and Implantation with a Slit Guide SLTGD

Planning prior to implantation requires selecting and defining the vector of implantation V, whereafter the guide shell GDS may be designed and fabricated. By help of the three-dimensional imaging facilities and of computer processing facilities running computer programs, such as CAD/CAM computer programs for example, a dentist may derive data to select and define a vector V of implantation of one or more zygomatic implants ZI. In turn, based on the derived data, a technician may design and produce an individual tailor-made guide shell GDS in conformance with the topography of the maxilla MAX of a patient by use of a three-dimensional lithographic additive printer for example. Evidently, the topography of the maxilla MAX which is different for each individual, has to be retrieved a priori.

Preparations prior to use assume that a vector V has been defined and that tissue covering the maxillary bone MAX has been folded-over, or removed, to expose a naked bone portion of the maxilla MAX.

Use, in broad terms, may include the following steps involved in the use of the exemplary embodiments of the apparatus APP with a guide shell GDS supporting three guides TRGD.

Use of the apparatus APP requires as a first step, that the guide shell GDS be properly disposed and releasably affixed to and in conformance with the topography of the maxilla MAX, such that the pair of guides PRGD are correctly oriented relative to the vector V. In FIG. 24, the implantation vector V is represented by the segment of line stretching from VA to VC and the three guides TRGD are oriented accordingly.

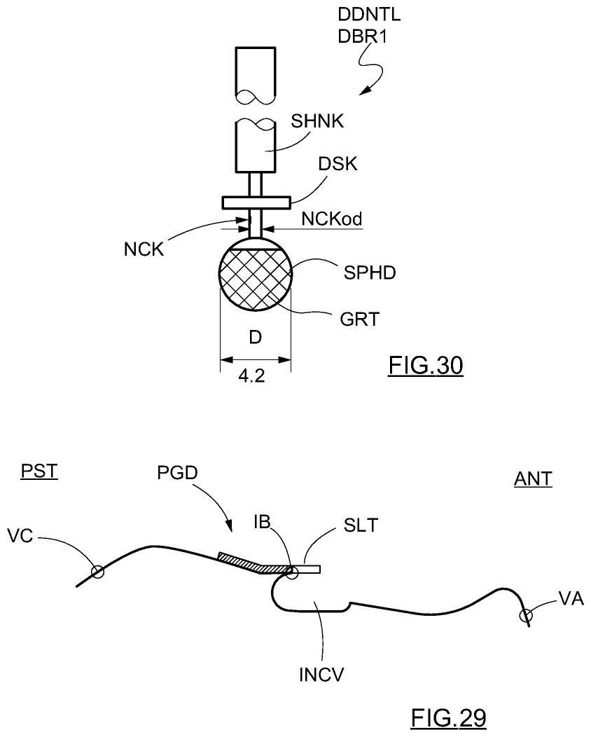

FIG. 29 illustrates the result of a first initial osteotomic step performed to create the initial cavity INCV under guidance of the slit guide SLTGD and of the posterior guide PGD, by use of a first dedicated dental burr tool DDNTL, here a dedicated spherical headed burr tool DBR1 shown in FIG. 30.

In FIG. 30, the dedicated osteotomic burr tool DBR1 is shown to have an abrasive coated spherical head SPHD which is coupled via a neck piece NCK supporting a disk DSK, to a shank SHNK which terminates the dedicated burr DBR1. The spherical abrasive coated head SPHD may have an exterior diameter D, say with D=4.2 mm, the same as the exterior diameter of a zygomatic implant ZI, and from which the neck piece NCK extends. The exterior diameter NCKod of the neck NCK is smaller than the width W of the slit SLT shown in FIG. 26, and is configured to engage the slit SLT in sliding fit.

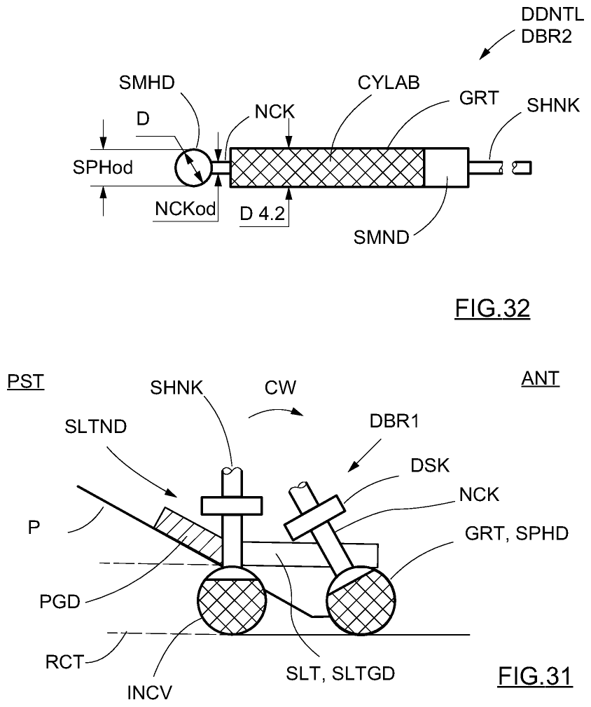

FIG. 31 depicts the posterior guide PGD, the silt guide SLTGD with the slit SLT and the slit end SLND, and the use of the first dedicated burr DBR1 to form an initial cavity INCV. In a first position (1), the shank SHNK is engaged slant relative to the slit SLT of the slit guide SLTGD, and the disk DSK is supported by the posterior guide PGD. The neck piece NCK is guided by the slit guide SLTGD, and the spherical head SPHD of the first dedicated burr DBR1 is disposed on the maxilla MAX. Next, to open the initial cavity INCV shown in FIG. 29, the dedicated burr DBR1, guided by the slit guide SLTGD and by the posterior guide PGD, is rotated, say by a handpiece, not shown, to cut a first portion of the cavity INCV into the maxilla MAX. Then, the rotating dedicated burr tool DBR1 is pivoted about the spherical head SPHD as a fulcrum, along the slit SLT of the slit guide SLTGD. During osteotomy with the spherical head SPHD, in translation and in pivotal motion of the dedicated burr DBR1, the disk DSK is guided by and guides by sliding on the posterior guide PGD. Pivotal motion of the dedicated burr DBR1 away from the slant position (1) by clockwise motion as shown by the arrow CW, may continue until the dedicated burr DBR1 reaches a straightened position shown as position (2). Further, the neck piece NCK may be pushed posteriorly along the slit SLT until the neck NCK is arrested by the slit end SLND, and the dedicated burr DBR1 may be manipulated until the initial cavity INCV is formed.

It is noted that to avoid abrasion of the slit SLD and the posterior guide PGD, the neck piece NCK and the portion of the spherical head SPHD adjacent the neck NCK, are kept smooth while the remaining portion of that head SPHD may be covered with abrasive diamond, tungsten carbide, or titanium grit GRT, as shown in FIG. 30. Once the dedicated burr DBR1 has opened the length of the cavity INCV to the depth of the diameter D, say with D=4.2 mm of the spherical head SPHD, that initial cavity INCV is completed, the first dedicated burr DBR1 may be retrieved anteriorly out of the slit guide SLTGD, out of the posterior guide PGD, and out of the cavity INCV.

The second osteotomic step may take advantage of the initial cavity INCV created by the first osteotomic step to open an anterior recess RCS extending from the initial cavity INCV up to point VA. A second dedicated dental tool DDNTL, here a dedicated burr tool DBR2 having a smooth head SMHD and a generally cylindrical abrasive body CYLAB which supports a shank SHNK, as shown in FIG. 32, may be used to open the recess RCS.

FIG. 32 shows the dedicated dental burr tool DBR2 to have a spherical smooth head SMHD coupled via a neck piece NCK to the cylindrical abrasive body CYLAB of diameter D, wherein D may be equal to 4.2 mm, and thus equal to the diameter of a zygomatic implant ZI. A shank SHNK is coupled to the abrasive coated body CYLAB, which may be covered with abrasive diamond, tungsten carbide, or titanium grit GRT, or be made as a bone chipping tool made out of steel for example. As shown in FIG. 32, the shank SHNK terminates the second dedicated burr DBR2. The neck piece NCK is cylindrical but has to engage the slit SLT in sliding fit and thus has an exterior diameter NCKod which is smaller than the width W of the longitudinal slit SLT shown in FIG. 26. With the spherical smooth head SMHD as a fulcrum and the neck NCK in the slit SLT, the abrasive body CYLAB of the dedicated burr tool DBR2 is allowed pivotal motion in the plane defined by the slit SLT.

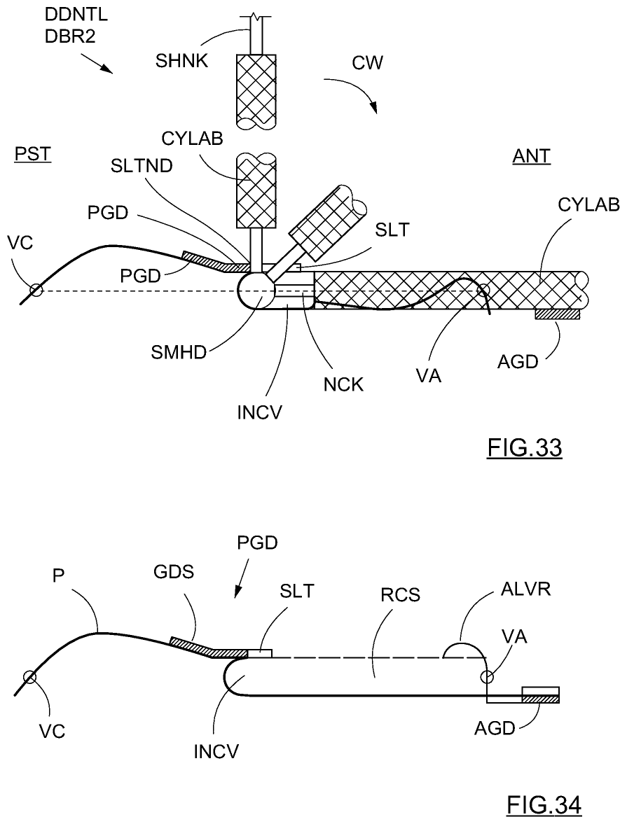

FIG. 33 illustrates the use of the dedicated burr DBR2 having a cylindrical abrasive portion CYLAB for opening a recess RCS extending anteriorly from and away of the posterior guide PGD. The dedicated burr tool DBR2 is shown in three dispositions in FIG. 33, i.e. a possible first initial disposition (3), a second pivoted disposition (4), and a third end disposition (5) when seated in the anterior guide AGD. For the initial disposition (3), the dedicated burr tool DBR2 is inserted by the neck NCK into the slit SLT of the slit guide SLTGD, thus with the smooth spherical head SMHD into the initial cavity INCV as a fulcrum, and is operated into rotation by a hand piece, which is not shown. The dedicated burr tool DBR2 is then rotated by the handpiece and is pivoted in the clockwise direction CW, shown in FIG. 33 by the arrow marked CW, towards the second disposition (4), shown partially, and is still further pivoted until the cylindrical abrasive portion CYLAB is seated in the anterior guide AGD, whereby the osteotomy of the recess RCS opening procedure is ended. If desired, the dedicated burr tool DBR2 may have a cylindrical smooth end portion SMND, as shown in FIG. 32, to prevent abrasion of the anterior guide AGD when seated therein. The dedicated burr DBR2 may be retrieved out of the recess RCS which is open and exposed as schematically shown in FIG. 34. The second osteotomy step has thus been started under the guidance of the posterior guide PGD and of the slit guide SLTGD and is ended when the dedicated burr tool DBR2 is firmly seated in the anterior guide AGD.

FIG. 35 illustrates an exemplary dedicated sleeve guide SLVGD with a bushing BSH having an exterior diameter D, which bushing matches at least the posterior guide PGD. The bushing BSH may have an interior diameter BSHid which is adapted for use with a dental tool, for example a dental drill tool DRL or another tool. Dedicated sleeve guides SLVGD of different interior diameter BSHid may be used with different diameter-matching dental drills DRL such as for example various preliminary drills PRDRL. A handle HDL may be coupled to the bushing BSH, perpendicular to the axis X thereof. The handle HDL allows a user to hold and insert the bushing BSH into the open initial cavity INCV in the posterior guide PGD which will receive the bushing BSH in retention and in alignment with the vector V. A preliminary drill PRDRL supported in the anterior guide AGD and axially centered by the dedicated sleeve guide SLVGD, will thus be coaxially aligned with the vector V.

The bushing BSH is coupled to a threaded pin TRDPN forming a threaded neck TRNCK which extends away thereout perpendicular to the X-axis of the bushing BSH. The threaded pin TRDPN has a male screw thread MTRD of exterior diameter PNod accommodated to fit in sliding fit in the slit SLT of the slit guide SLTGD. The handle HDL is hollow and supports a female screw thread FMTRD matching the male screw thread MTRD of the threaded pin TRDPN. With the handle HDL engaged less than completely on the threaded pin TRDPN, the uncovered portion of the male screw thread MTRD is configured to slidingly fit in the slit SLT of the slit guide SLTGD. The bushing BSH may thus be engaged and seated in the posterior guide PGD with the male screw thread MTRD in the slit SLT. Thereafter, the handle HDL is screw threaded onto the threaded pin TRDPN until the bushing BSH is mechanically clamped in the posterior guide PSG. Thereby, the bushing BSH is oriented in accurate axial direction in alignment with the vector V.

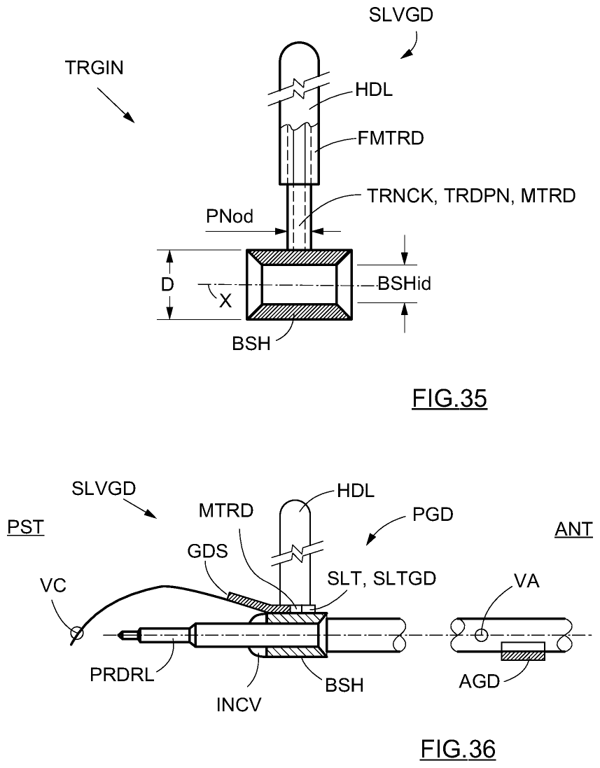

FIG. 36 shows the sleeve guide SLVGD with the bushing BSH fixedly clamped in the posterior PGD. The handle HDL has been rotated on the threaded pin TRDPN such that the male screw thread MTRD is barely seen in the slit SLT of the slit guide SLTGD. Only a small cross-section portion of the guide shell GDS is shown in FIG. 36.

In FIG. 36, the preliminary drill PRDRL is axially centered in and by the interior diameter BSHid of the sleeve guide SLVGD which is axially oriented by the posterior guide PGD, and is firmly inserted in the anterior guide AGD. The preliminary drill PRDRL is mounted for rotation in a handpiece which is not shown, and is then introduced in the sleeve guide SLVGD and is firmly seated into the anterior guide AGD. The preliminary drill PRDRL is now rotated by use of the handpiece. A preliminary bore PRLBR is drilled starting from the initial first cavity INCV and until the preliminary drill PRDRL is arrested by the bushing BSH, as shown in FIG. 36. Thereafter, the preliminary drill PRDRL is retrieved out of the bushing BSH, as well as the sleeve guide SLVGD.

Sets of dedicated sleeve guides SLVGD with different bushing BSH of interior diameter BSHid may be provided for use with matching dental drills DRL. If desired, the use of another dedicated sleeve guide SLVGD having a bushing interior diameter BSHid larger than a previously used one, but smaller than the exterior diameter of the implantation drill IMPBR, may be used for another preliminary drill PRDRL. Thereafter, the preliminary drill PRDRL and the sleeve guide SLVGD may be removed out and away of the guide shell GDS.

In a further step, the implant bore IMPBR may be drilled in guidance by the pair of guides PRGD and by the bore of a preceding preliminary drilling operation. To this end, the implantation drill IMDRL is mounted for rotation by a handpiece, which is not shown. In turn, the implantation drill IMDRL is disposed in the pair of guides PRGD, and the forces of a moment M are applied on the mutually inverted anterior guide AGD and posterior guide PGD, whereby the drill will be coaxially aligned with the vector V. As depicted hereinabove, a detail illustrated in FIG. 20 shows the diameter D of the implantation bore IMPBR of say 4.2 mm for example, being urged into the posterior guide PGD. The implantation drill IMDRL is introduced in the preliminary bore PRLBR and is then rotated to drill to the desired depth, possibly by help of the depth marks stamped on the shank of the implantation drill IMDRL. The depth graduation signs may be of assistance to prevent drilling beyond the point VC shown in FIG. 24. Finally, the implantation drill IMDRL is retrieved out of the guide shell GDS, and the zygomatic implant ZI may be inserted in guidance by the pair of guides PRGD for coincidence with the vector V, and anchored.

After implantation, the gap(s) GAP opened in the guide shell GDS permit release thereof from the maxilla MAX.

It is noted that sometimes the use of the dedicated sleeve guide SLVGD may be omitted when after opening of the recess RCS, an implantation drill IMDRL supported by and forced by a moment M into the pair of guides PRGD may suffice to drill the implantation bore IMPBR.

However, it is a preferable practice to take benefit from the ability of the same dedicated sleeve guide SLVGD to operate as both, once as a fulcrum for a burr to open a recess RCS, and once as a drill guide DRLGD for drilling a bore. Thereby, the same dedicated dental tool DDNTL may be used in sequence for opening the recess RCS and for drilling a preliminary drill bore PRLBR, with all the advantages provided thereby.

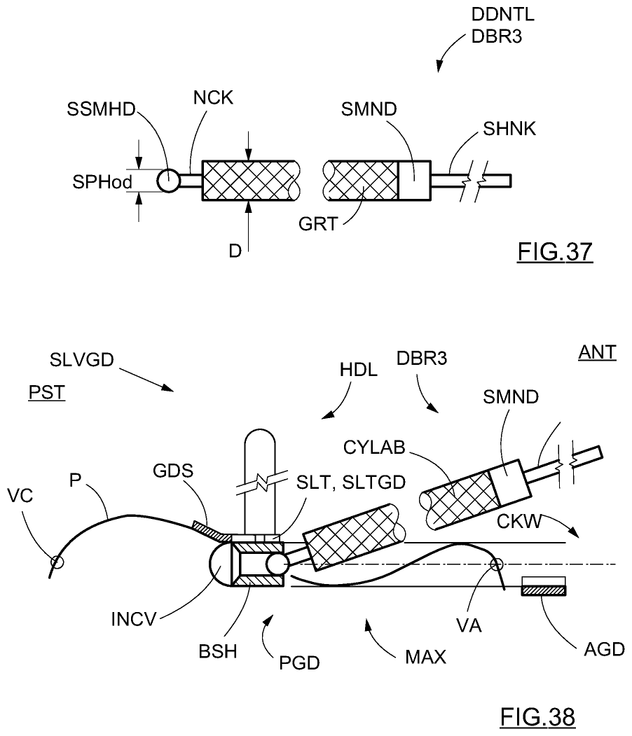

FIG. 37 depicts an exemplary dedicated third burr tool DBR3 for use with the dedicated sleeve guide SLVGD. The dedicated third burr DBR3 may have a spherical small smooth head SSMHD coupled via a neck piece NCK, to a cylindrical abrasive body CYLAB of diameter D. The spherical small smooth head SMHD has an exterior diameter SPHod selected to slidingly fit the interior diameter BSHid of the dedicated sleeve guide SLVGD when inserted therein. Evidently, the exterior diameter SPHod of the spherical small smooth head SMHD is smaller than the diameter D of the cylindrical abrasive body CYLAB which may be selected as 4.2 mm. A shank SHNK is coupled to the abrasive coated body CYLAB, which may be covered with abrasive diamond, tungsten carbide, or titanium grit GRT, or be made as a bone chipping tool made out of steel for example. The neck piece NCK is cylindrical and to engage the slit SLT in sliding fit, has an exterior diameter NCKod which is smaller than the width W of the longitudinal slit SLT shown in FIG. 26. Furthermore, the neck piece NCK is sufficiently long for engagement in the interior diameter BSHid of the dedicated sleeve guide SLVGD, which interior diameter BSHid has to provide support as a fulcrum to permit pivotal freedom of motion as shown in FIG. 38. The shank SHNK terminates the third dedicated burr DBR3.

FIG. 38 shows the third dedicated burr DBR3, the shank SHNK of which may be rotated by a handpiece, not shown. The spherical small smooth head SSMHD is introduced in the interior diameter BSHid of the dedicated sleeve guide SLVGD which operates as a fulcrum, and the neck NCK is engaged in the slit SLT. Next, the abrasive body CYLAB of the dedicated burr tool DBR3 is rotated by the handpiece and is driven in pivotal motion in the plane defined by the slit SLT and the anterior guide AGD. The arrow marked CKW indicates a pivotal direction of motion to open a recess RCS in the maxilla MAX, similar to the pivotal motion of the second dedicated burr DBR2 shown in FIG. 33.

Once the recess RCS has been opened, the third dedicated burr DBR3 is retrieved but the dedicated sleeve guide SLVGD remains in place. A preliminary drill PRDRL of interior diameter matching the interior diameter BSHid of the bushing BSH may be mounted for rotation in a handpiece, not shown. The preliminary drill PRDRL is disposed for support by the anterior guide AGD and in drill axial centering support in the interior diameter BSHid of the bushing BSH, in the same disposition as shown in FIG. 36. Thereafter, the preliminary drill PRDRL is rotated. This time the dedicated sleeve guide SLVGD, hence the interior diameter BSHid, operates as a drill guide DRLGD for axially centering the preliminary drill PRDRL in alignment with the vector V. Drilling is stopped when the preliminary drill PRDRL is arrested by abutment on the bushing BSH, as shown in FIG. 36. The preliminary drill PRDRL and the dedicated sleeve guide SLVGD may be retrieved out of the guide shell GDS after completion of the preliminary bore PRLBR.

In a further step, the implantation drill IMDRL is mounted for rotation by a handpiece, which is not shown. In turn, the implantation drill IMDRL is disposed in support in the pair of guides PRGD, and the forces of a moment M are applied on the mutually inverted anterior guide AGD and posterior guide PGD, whereby the drill will be coaxially aligned with the vector V. A detail illustrated in FIG. 20 shows the diameter D, of say 4.2 mm for example, being urged into the posterior guide PGD. The implantation drill IMDRL is introduced in the preliminary bore PRLBR and is then rotated to drill to the desired depth, possibly by help of the depth marks stamped on the shank of the implantation drill IMDRL. The depth graduation signs may be of assistance to prevent drilling beyond the point VC shown in FIG. 24. Finally, the implantation drill IMDRL is retrieved out of the guide shell GDS, and the zygomatic implant ZI will be inserted in guidance by the pair of guides PRGD and of the implantation drill IMDRL, and anchored in coincidence with the vector V.

After implantation, the gap(s) GAP opened in the guide shell GDS permit release thereof from the maxilla MAX.

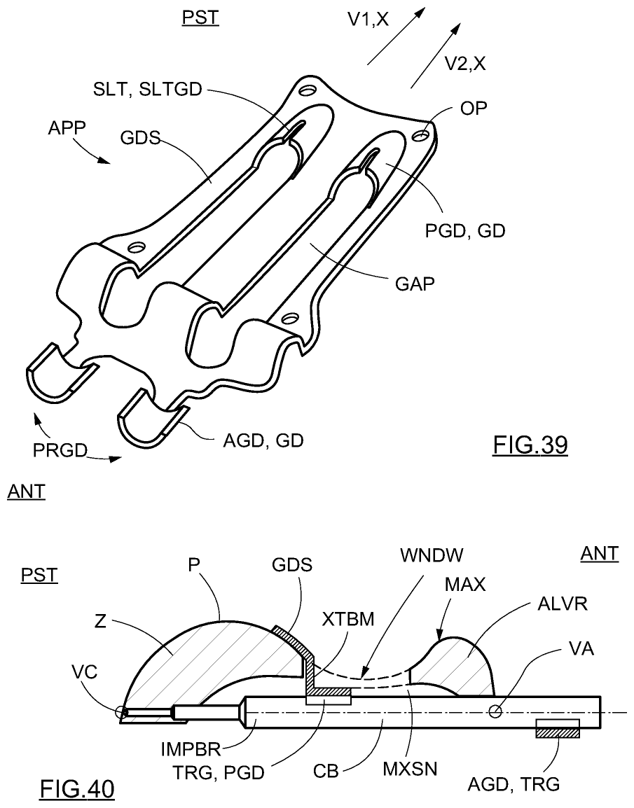

FIG. 39 is a schematic illustration of a guide shell GDS supporting two pairs of guides PRGD which are not parallel to each other but could be disposed in parallel. One pair of guides PRGD is aligned along the vector V1 and the other pair of guides is aligned along the vector V2. A guide shell GDS may thus support more than one pair of guides PRGD.

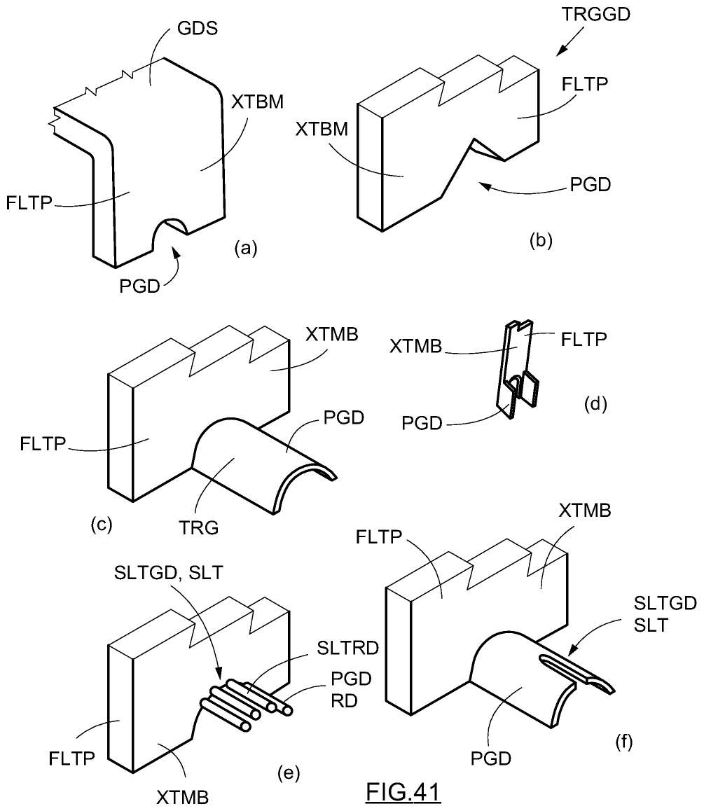

FIG. 40 schematically illustrates yet another exemplary embodiment of a portion of the guide shell GDS which supports three guides TRGD for guiding one intra sinusimplant. The three guides TRGD include an anterior guide AGD and a posterior guide PGD as one pair of guides PRGD, as well as a slit-guide SLTGD. The slit guide SLTGD is supported on the posterior guide PGD and is formed as a slit SLT therein. When the guide shell GDS is releasably affixed onto uncovered bone, the pair of guides PRG and the slit guide SLTGD are oriented parallel to the vector V, but the posterior guide PGD is disposed in the maxillary sinus MXSN.

The description related hereinabove to the apparatus APP with reference to the FIGS. 1 to 11 and 24 to 27 is still valid for the guide shell GDS which supports three guides TRGD for guiding one intra sinus implantation, and is therefore not repeated.

FIG. 40 depicts a cross-section through the maxilla MAX for an intra-sinus implantation of a zygomatic implant ZI. The profile line P shows the points VA and VC which demarcate the implantation vector V. The anterior guides AGD may be the same or similar to those described hereinabove. However, the posterior guide PGD is disposed in the maxillary sinus MXSN after penetration therein via a window WNDW which has been opened in the wall of the maxillary sinus MXSN. From the partially shown guide shell GDS, which is releasably affixed to and in conformation with the maxilla MAX, an extension member XTMB extends and penetrates into the maxillary sinus MXSN, via the maxillary window WNDW, to support the posterior guide PGD therein. Thereby, the mutually inverted pair of guides PRGD will maintain a cylindrical body CB in firm seated support therein when a moment of forces M is applied on that cylindrical body CB, as described hereinabove with reference to FIG. 7. For example, the cylindrical body CB may represent a cylindrical portion of a zygomatic implant ZI, or of a common dental tool DNT, or of a dedicated dental tool DDNTL, or of a preliminary drill PRDRL, or of an implantation drill IMDRL. FIG. 40 also shows the outline of an implantation bore IMPBR, thus also of the outline of a portion of a cylindrical body CB which may be disposed in the implant bore IMPBR and be supported by the pair of guides PRG.

In FIG. 41, from 41(a) to 41(f), there are depicted exemplary posterior guides PGD, out of many other possible variations which may pertain to the collection of trough guides TRGGD that may be coupled to the extension member EXMB.

For the sake of clarity of illustration, the guide shell GDS is not shown but for a portion thereof in FIG. 41(a), and in FIGS. 41(b) to 41(f), only a portion of the extension member XTMB is shown, and that as a flat piece FLTP even though that flat piece could be rigidized say by use of rib(s) for example. The flat piece FLTP is a conceptual representation of a member which may be implemented in various shapes.

FIGS. 41(a) and 41(b) show a posterior guide PGD configured as a cut-out of the flat piece FLTP, as respectively, a segment of a circle and a V-shape. The exemplary embodiments from FIG. 41(a) to FIG. 41(e) may be configured to support or guide a cylindrical body CB of diameter D, with D=4.2 mm for example.

In FIG. 41(c) the posterior guide PGD is formed as a trough TRG cantilevered to the extension member XTMB, which trough TRG is inverted relative to the anterior guide AGD shown in FIG. 40.

FIG. 41(d) depicts a posterior guide PGD which folds out of the flat piece FLTP to form two arms whereby a cylindrical body CB may be supported.

FIG. 41(e) shows a posterior guide PGD with four rods RD, with two rods forming the guide rods GRD for a cylindrical body CB, and two slit rods SLTRD forming the slit SLT of the slit guide SLTGD.

Finally, FIG. 41(f) depicts a trough TRG like the one shown in FIG. 41(c) but with a slit guide SLTGD and a lit SLT.

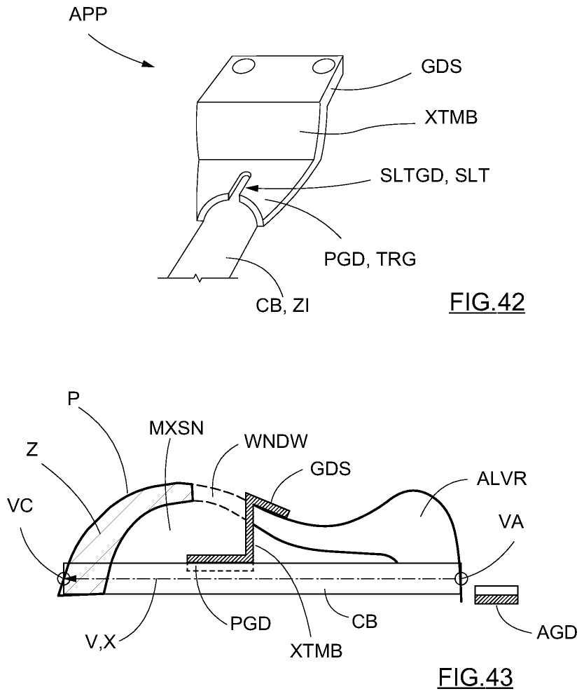

FIG. 42 illustrates a detail of a portion of the guide shell GDS which supports the extension member XTMB, the posterior guide PGD and the slit guide SLTGD with the slit SLT. For the sake of ease of illustration, the posterior guide PGD is selected as a trough TRG. With the guide shell GDS on the maxilla MAX, and the slit guide SLTGD disposed parallel to the vector V, the extension member XTMB is retained in the maxillary sinus MXSN and the posterior guide PGD is oriented in alignment with the anterior guide AGD, which is not shown in FIG. 42.

FIG. 43 is similar to FIG. 40 but for the disposition of the window WNDW and of the posterior guide PGD which are disposed posteriorly of the extension member XTMB.

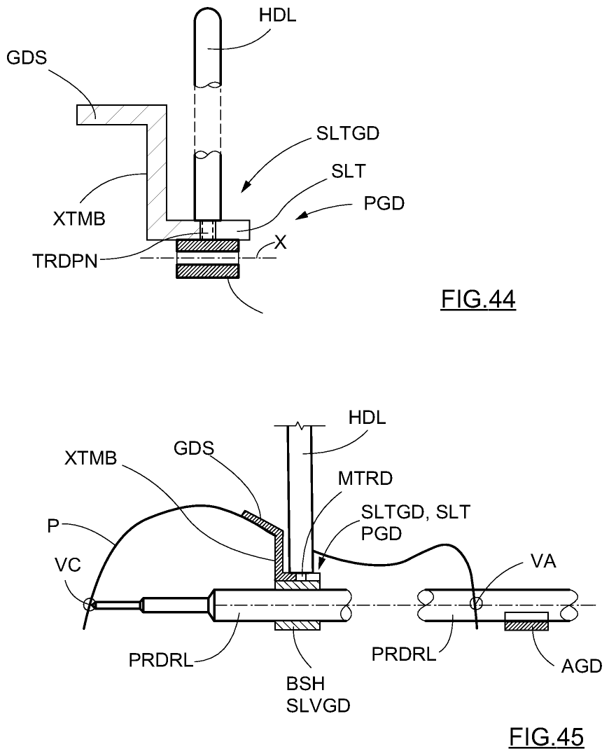

FIG. 44 illustrates a detail showing a portion of the guide shell GDS and of the posterior guide PGD wherein the dedicated sleeve guide SLVGD shown in FIG. 35 is firmly retained. The description related to the implementation, the operation and the use of the dedicated sleeve guide SLVGD as presented hereinabove is believed to be clear to those skilled in the art, and is therefore is not repeated.

### Planning, Preparations, and Intra Sinus Implantation

Planning prior to implantation requires selecting and defining the vector of implantation V and the location and dimensions of the window WNDW, whereafter the guide shell GDS may be designed and fabricated.

By help of the three-dimensional imaging facilities and of computer processing facilities running computer programs, such as CAD/CAM computer programs for example, a dentist may select and define a vector V of implantation of one or more zygomatic implants ZI. The same imaging facilities and processing facilities may be used to define the location and size of the window WNDW. The location and the size may be defined relative to the vector V as a segment of a line and to one or more points on the vector V, such as point VA and VC for example. In turn, based on the vector(s) V, a technician may design and produce an individual tailor-made guide shell GDS in conformance with the topography of the maxilla MAX of a patient by use of a three-dimensional lithographic additive printer for example. Evidently, the topography of the maxilla MAX which is different for each individual, has to be retrieved a priori.

Preparations prior to use assume that a vector V has been defined, that tissue covering the maxillary bone MAX has been folded-over, or removed, to expose a naked bone portion of the maxilla MAX, and a window WNDW has been opened in the maxillary sinus wall.

Use, in broad terms, may consider the following steps involved in the use of the exemplary embodiments of the apparatus APP.

As a first step, the guide shell GDS has to be properly disposed and releasably affixed to and in conformance with the topography of the maxilla MAX, such that the three guides TRGD are correctly oriented relative to the vector V. Thereby, as shown in FIG. 40, the posterior guide PGD may be introduced via the window WNDW and into the maxillary sinus MXSN.

In a second step, the dedicated sleeve guide SLVGD is inserted in the posterior guide PGD with the uncovered portion of the threaded pin TRDPN engaged in the slit SLT of the slit guide SLTGD. Next, the handle HDL is screw threaded to fixedly clamp the bushing BSH into firm seated disposition in the posterior guide PGD. Thereby, the bushing BSH is oriented in accurate direction in alignment with the vector V. A cylindrical body CB passing through the bushing BSH is thus aligned with the vector V and certainly so when further supported by the anterior guide AGD.

As a third step, the dedicated sleeve guide SLVGD is used to drill a preliminary bore PRLBR. FIG. 45 shows the sleeve guide SLVGD with the bushing BSH fixedly clamped in the posterior PGD. The handle HDL of the sleeve guide SLVGD has been rotated on the threaded pin TRDPN such that the male screw thread MTRD is barely seen in the slit SLT of the slit guide SLTGD. Only a small cross-section portion of the guide shell GDS is shown in FIG. 45.

A preliminary drill PRDRL is used to drill a preliminary bore PRLBR which is bored by use of a handpiece which is not shown. Evidently, the preliminary drill PRDRL has first to be mounted before being rotated. The preliminary bore PRLBR is drilled from the anterior point VA towards and via the bushing BSH which may be visible through the window WNDW, and into the zygomatic bone Z, until arrested by the bushing BSH, as shown in FIG. 45. FIG. 36 also illustrates a preliminary drill PRDRL arrested by the bushing BSH. Thereafter, the preliminary drill PRDRL and the sleeve guide SLVGD are removed. If desired, the preliminary drill PRDRL may be used to open an entry point in the alveolar crest ALVR prior to drilling of the preliminary bore PRLBR.

The fourth step includes insertion of the implantation drill IMDRL as shown in FIG.

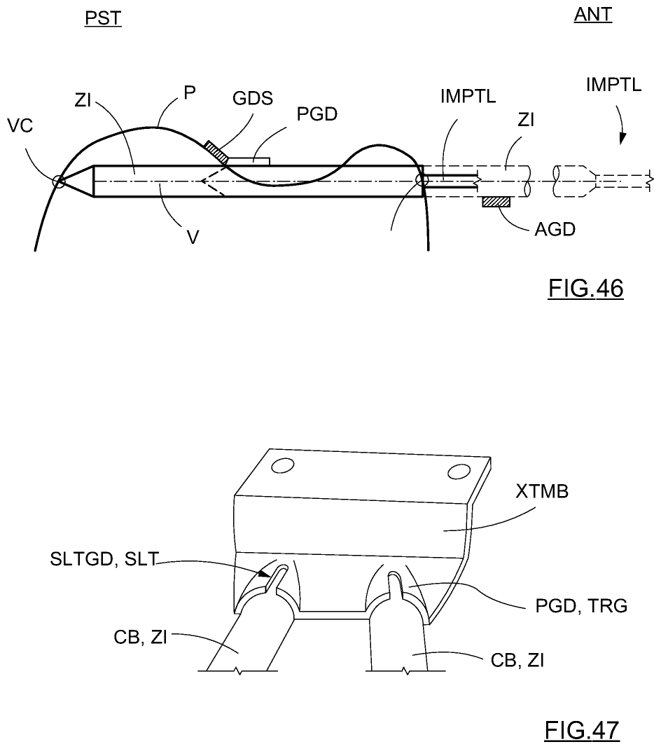

40. The implantation drill IMDRL is disposed in support of the pair of guides PRGD and into the preliminary bore PRLBR. Now that the preliminary bore PRLBR has been drilled, the implantation drill IMDRL may find support in the posterior guide PGD, in the same manner as depicted in FIG. 20. A moment of forces M is applied on the implantation drill IMDRL, and the implant bore IMPBR is drilled open. Evidently, the implantation drill IMDRL has first to be mounted in and rotated by a handpiece which is not shown. Next, at a first stage STG1, the zygomatic implant ZI is disposed on the pair of guides PRG as shown in FIG. 46, and is driven for insertion at the second stage STG2, into the implant bore IMPBR by help of implant tool IMPTL. At the second stage STG2, the zygomatic implant ZI is seated in the implant bore IMPBR in coincidence with the vector V and is anchored into the zygoma bone Z by help of the implant tool IMPTL. According to design of the gap GAP, the guide shell GDS may be released from the maxilla MAX even after anchoring of the zygomatic implant ZI.

FIG. 47 isometrically illustrates a guide shell for two intra sinus implantations. This example of a guide shell includes two sets of three trough guides, each set including an anterior guide AGD, a posterior guide PGD, and a slit guide SLTGD with a slit SLT. The two sets of guides are not parallel to each other but could be disposed in parallel. FIG. 47 specifically illustrates an extension member XTMB and two posterior guides PGD and two slit guides SLTGD of the guide shell for two intra sinus implantations.

Building of the apparatus APP and of the dedicated dental tools DDNTL does not need to be described because it will be obvious to those skilled in the art. Use of the apparatus APP has been described in detail hereinabove and is therefore not repeated.

There have thus been described an apparatus APP for a product and for a method for implanting zygomatic implant(s) ZI in coincidence with a previously derived implantation vector V, for extra maxillary implantation(s) and for intra sinus implantation(s). The apparatus APP may include dedicated dental tools DDNTL, which tools are configured for use during preparation and implantation, such as for osteotomy, under the guidance provided by the guide shell GDS. Dedicated dental tool DDNTL may include dedicated burrs DBR for osteotomy, drill guides DRLGD for support of axially centering thereof, and sleeve guides SLVGD as guides. Commonly available dental tools may include drill DRS, such as preliminary drills and implantation drills IMDRL.

The anterior guide AGD and the posterior guide PGD may be selected as practical, on condition that a cylindrical body CB remains stably supported as described hereinabove, in particular with reference to FIG. 7. Various exemplary shapes for the pair of guides PGD are shown in FIGS. 4 to 6, 9 to 11, 25 to 28, and in FIG. 41, and many other possible shapes may also be used. In general, the designations anterior guide AGD and posterior guide PGD refer to both the various described shapes as well as to other possible shapes. Anterior guide AGD and posterior guide PGD are thus generic names.

It is also possible to include the various described shapes as well as other possible shapes under the generic name of trough guides TRGGD. It can thus be said that each one guide GD out of the inverted pair of guides PRGD is configured as a trough guide TRGGD which includes at least two points of contact such that two trough guides TRGGD geometrically align and support a cylindrical body CB inserted therein in alignment with the vector V on a total of at least four points of contact.

Furthermore, one may consider a dedicated tool DDNTL for operation as an independent guide TRGIN (e.g., FIG. 35). For example, a sleeve guide SLVGD may possibly be supported say by the posterior guide PGD, and be used to guide another tool without help from the anterior guide AGD. In such a case, it could be said that each one guide GD configured for independent operation is an independent guide TRGIN which includes at least three points of contact to geometrically align and support a cylindrical body CB inserted therein in alignment with the vector V.

1. An apparatus for implantation of a zygomatic implant in coincidence with an implantation vector, the apparatus comprising:
a dedicated dental tool; and
a dental implantation guide comprising a guide shell configured to conform to and to be releasably affixed to a portion of a maxillary bone,
wherein the guide shell supports a plurality of guides including an anterior guide and a posterior guide which together form a pair of guides that are distanced apart relative to each other, are configured to be aligned with the implantation vector, and are configured as concave troughs for support of a cylindrical body, the cylindrical body being at least one of the zygomatic implant, the dedicated dental tool, an implantation drill, and a preliminary drill,
wherein the dedicated dental tool includes a dedicated burr, the dedicated burr comprising:
a smooth spherical head configured for guidance by the posterior guide and operative as a fulcrum,
a cylindrical abrasive body, which is coupled to the spherical head by a neck, and which is configured for osteotomy, and
a shank which is coupled to the body,
wherein the dedicated burr is configured to be operated by rotating, and is configured to perform a pivotal motion about the fulcrum, to move into a plane defined by the posterior guide and the anterior guide until seated into the anterior guide, so as to open a recess parallel to the implantation vector in the maxilla,
wherein the dental implantation guide includes at least one gap pierced through the guide shell between the pair of guides, and configured for release of the guide shell from the maxilla,
wherein the pair of guides have inverted dispositions with respect to each other such that the concave trough of the anterior guide and the concave trough of the posterior guide are positioned to be in diametrically opposite dispositions relative to the cylindrical body that the pair of guides are configured to support, whereby a moment of forces applied about an axis perpendicular to a longitudinal axis of the cylindrical body urges the cylindrical body into stable and firm support in the pair of guides, whereby the cylindrical body is correctly aligned with the implantation vector.

2. The apparatus of claim 1, wherein the cylindrical body is the dedicated burr, and each of the anterior guide and the posterior guide covers at most half of a periphery of the dedicated burr.

3. The apparatus of claim 1, wherein the guide shell is configured for zygomatic implantation in a sinus which is one of an extra maxillary sinus and an intra maxillary sinus.

4. The apparatus of claim 1, further comprising a drill guide that is configured to be supported and guided by the posterior guide,
wherein the drill guide is configured to axially center the preliminary drill that is supported in the drill guide and urged into the anterior guide, in alignment with the implantation vector.

5. The apparatus of claim 1, wherein the guide shell is produced by three-dimensional lithographic additive printing.

6. The apparatus of claim 1, wherein the cylindrical body is the zygomatic implant.

7. The apparatus of claim 6, wherein the pair of guides are configured to limit the zygomatic implant to motion by rotation and longitudinal translation when the zygomatic implant is in firm seated disposition in the pair of guides.

8. The apparatus of claim 1, wherein at least one out of the pair of guides supports at least one pair of parallel rods disposed parallel to the implantation vector, the rods forming a guide configured to support a portion of the cylindrical body.

9. The apparatus of claim 1, further comprising a slit guide configured to guide the at least one dedicated dental tool in alignment with the implantation vector, wherein the slit guide comprises a slit in the posterior guide.

10. The apparatus of claim 9, wherein:
the at least one dedicated dental tool includes a first dedicated spherical headed burr tool comprising:
an abrasive-coated spherical head which is coupled via a neck piece to a shank which terminates the first dedicated spherical burr tool,
wherein:
the neck piece supports a disk between the spherical head and the shank,
the neck piece is configured to engage the slit guide to be guided by the slit, and
the disk is configured to limit movement of the first dedicated spherical headed burr tool in a direction perpendicular to the slit.

11. The apparatus of claim 9, wherein the at least one dedicated dental tool includes a sleeve guide configured to be inserted in the slit and to be releasably mechanically fixed to the posterior guide, and
wherein the sleeve guide is configured for operation as a drill guide for the preliminary drill and for operation as a fulcrum about which the dedicated burr is pivotable to perform osteotomy.

12. The apparatus of claim 9, wherein the plurality of guides supported by the guide shell comprise at least three guides including the pair of guides and the slit guide, and the at least three guides are mutually operative for guiding implantation preparations and for implantation of the zygomatic implant.

13. The apparatus of claim 9, wherein:
the slit guide is formed in the posterior guide as at least one pair of parallel slit rods for disposition parallel to the implantation vector.

14. The apparatus of claim 1, wherein an extension member projects downward from the guide shell, the posterior guide is positioned on the extension member, and the posterior guide extends in an anterior or posterior direction from the extension member, and
wherein the posterior guide is configured to be disposed in a maxillary sinus.

15. A method for constructing an apparatus for implanting a zygomatic implant in coincidence with an implantation vector, the method comprising:
providing at least one dedicated dental tool and a dental implantation guide comprising a guide shell, the guide shell being configured to conform with and to be releasably fixed to a portion of a maxillary bone, wherein the guide shell supports a plurality of guides including an anterior guide and a posterior guide which together form a pair of guides that are distanced apart relative to each other and are configured to be aligned with the implantation vector,
selecting a cylindrical body CB, which is one of the zygomatic implant ZI, a dental drill, and the dedicated dental tool, for use with the guide shell, and
disposing the cylindrical body CB in the pair of guides,
wherein the pair of guides are shaped as concave troughs for receiving the cylindrical body therein, and have inverted dispositions with respect to each other such that the concave trough of the anterior guide and the concave trough of the posterior guide are positioned to be in diametrically opposite dispositions relative to the cylindrical body,
wherein application of a moment of forces about an axis perpendicular to a longitudinal axis of the cylindrical body urges the cylindrical body into stable and firm support in the pair of guides, whereby the cylindrical body is coaxially aligned with the vector, and
wherein the at least one dedicated dental tool includes a dedicated burr, the dedicated burr comprising:
a smooth spherical head configured for guidance by the posterior guide and operative as a fulcrum,
a cylindrical abrasive body, which is coupled to the spherical head by a neck, and which is configured for osteotomy, and
a shank SHNK which is coupled to the body,
wherein the dedicated burr is configured to be operated by rotating, and is configured to perform a pivotal motion about the fulcrum, to move into a plane defined by the posterior guide and the anterior guide until seated into the anterior guide, so as to open a recess parallel to the vector in the maxilla.

16. The method of claim 15, wherein each of the guides supports the cylindrical body by at least two points of contact such that the pair of guides geometrically align and support the cylindrical body disposed therein in alignment with the implantation vector on at least four points of contact.

17. The method of claim 16, further comprising:
configuring each of the guides for independent operation as an independent guide which includes at least three points of contact for geometrically aligning and supporting the cylindrical body disposed therein in alignment with the vector.

18. The method of claim 17, further comprising:
providing a slit guide which comprises a slit in the posterior guide; and
wherein the neck of the dedicated burr is configured to engage the slit guide.

19. The method of claim 15, further comprising:
providing a slit guide which comprises a slit in the posterior guide; and
providing another dedicated dental tool which comprises a sleeve guide which is configured to be guided by at least one the slit guide, the posterior guide, and both the slit guide and the posterior guide, and is further configured to operate as at least one of a fulcrum and a drill guide.

20. The method of claim 15, further comprising:
providing the guide shell to have at least one gap pierced therethrough for release of the guide shell from the maxilla after implantation of the zygomatic implant.

21. The method of claim 15, further comprising:
providing a slit guide which comprises a slit in the posterior guide; and
providing another dedicated dental tool comprising a disk and a neck configured for, respectively, support by the posterior guide and guidance by the slit guide.
